(19) United States
(12) Patent Application Publication
(10) Pub. No.: US 2012/0123829 A1
(43) Pub. Date: May 17, 2012

(54) INDEPENDENT CARRIER ETHERNET INTERCONNECTION PLATFORM

(75) Inventors: Zinan Chen, Marina Del Rey, CA (US); Ronald Gavillet, Winnetka, IL (US); Chris Purdy, Costa Mesa, CA (US)

(73) Assignee: CENX, Inc., Winnetka, IL (US)

(21) Appl. No.: 13/387,646

(22) PCT Filed: Jul. 29, 2010
(86) PCT No.: PCT/US10/43732

§ 371 Date: Jan. 27, 2012

Related U.S. Application Data
(60) Provisional application No. 61/230,069, filed on Jul. 30, 2009.

(51) Int. Cl. G06F 15/16; G06Q 30/02; G06F 15/173; G06Q 30/00

(52) U.S. Cl. 705/14.4; 705/26.1; 705/27.1; 709/230; 709/224

(57) ABSTRACT

A communications system is provided for enabling a plurality of service providers to interconnect via an Ethernet platform, the plurality of service providers employing disparate Ethernet protocols. The system includes a central server and a plurality of switching locations. Each one of the plurality of switching locations is communicatively connected to the central server and to the plurality of service providers. Each of the plurality of switching locations includes a plurality of Ethernet router switches, a monitoring device, a local server coupled to a plurality of databases. Each of the plurality of databases is associated with each of the service providers. A communications media is provided for interconnecting the plurality of switches, the service providers, the router switches, the connectivity device, and the local server. The system enables the service providers to be interconnected on the Ethernet platform by establishing protocol mappings between any two Ethernet protocols associated with corresponding service providers.

### CROSS-REFERENCE

This international patent application claims priority to U.S. Provisional Patent Application No. 61/230,069 filed on Jul. 30, 2009, which is incorporated by reference herein in its entirety.

### TECHNICAL FIELD

This invention generally relates to data transmission, and more particularly to an independent, service provider interconnection platform with advanced switching capabilities and centralized monitoring to enable rapid and efficient provisioning of Carrier Ethernet services between multiple service provider networks.

### BACKGROUND OF THE INVENTION

As service providers strive to increase revenues by integrating new data, voice, and video service offerings, they are also, for efficiency reasons, converging their networks to support these services over a single Internet Protocol (IP) infrastructure. To best enable this convergence, service providers are migrating to Ethernet, a highly efficient technology originally used inside premises, as the connectivity standard for transporting these services. Ethernet's cost-effectiveness is due to several factors, including its prevalence as the de facto standard for providing computer to computer connectivity. To facilitate the use of Ethernet beyond the premises and across wide areas, Carrier Ethernet service standards were developed by the Metro Ethernet Forum (MEF).

Standardized, carrier-class Carrier Ethernet service is defined by five attributes—standardization, reliability, scalability, quality of service, and service management—that distinguish it from familiar local area network or LAN-based Ethernet.

These Carrier Ethernet standards have helped to standardize hardware for the deployment of Carrier Ethernet as well as establish initial service level standards defining Carrier Ethernet services. For example, there are various classes of Carrier Ethernet service that have been defined, each with prescribed technical characteristics. Which class of service is ordered depends on the use (e.g., data, voice, and video) that the end user plans to make of the service.

Recently, the MEF adopted standards to address network-to-network interfaces (NNIs) between service providers. NNIs between multiple service providers are needed for Carrier Ethernet to be deployed on an end-to-end basis for customers because no service provider has universal or a ubiquitous coverage area. Creating Ethernet NNI interconnection standards has taken several years due to the vast differences and incompatibilities between service providers' networks, systems and services. The MEF released in January 2010 a standard for these NNI connections. The released standard is referred to as the MEF 26 Standard, defining Phase I of the external network to network interface (“ENNI”). This MEF 26 standard, however, does not, of course, significantly mitigate the time, resources, cost and coordination of actually implementing the NNI interconnection. Thus, this standard defines a language for describing the NNI interconnections but not all of the detailed Ethernet services, thus allowing carriers to continue to maintain flexibility in their service offering. The significant differences between service providers' network, systems and services will still make implementation of the NNI standards a very extensive effort that could take years to complete, potentially slowing Carrier Ethernet adoption for years to come.

Moreover, because of the large number of service providers, with each serving unique territories or geographic areas, numerous NNI standards-based connections will need to be put in place among all the various service providers in order to deploy Carrier Ethernet on an end-to-end basis; this is commonly referred to as the N² problem, where the total number of connections required is defined by the product “N*(N−1)” which is approximately equal to the square of the number “N” of service providers needing to interconnect.

100081 As FIG. 1 shows, when, for example, service provider C 101 (letters A-Y on FIG. 1 represent service providers) needs to establish an interconnection with another service provider, service provider Y 103, in order to extend service provider C's Ethernet service capability into the region served by service provider Y 103, service provider C 101 must establish an NNI connection with service provider Y 103. To do this, service provider C 101 must engineer, install and manage an NM transport facility 102 of some type, e.g., fiber optic, between service provider C 101 and Y 103. Likewise, when service provider C 101 in FIG. 1 needs to interconnect with, for example, service provider B 105 to again extend service provider C's Ethernet service capability, service provider C 101 must engineer, install and manage a new NNI transport facility 104 between service provider C 101 and service provider B 105. This effort must be repeated between each individual service provider seeking to interconnect with every other service provider.

The significant interconnection technical challenges associated with establishing NNI interconnections have been recognized by the few service providers that, due to customer demand, have gone through the effort of establishing NNI interconnections with other service providers in order to provide end-to-end Carrier Ethernet. The costs, delays, and challenges of such NNI interconnections have made this a limited option.

In order to reduce the efforts and costs associated with NNI interconnection, some service providers have sought to leverage their mutual collocation at certain carrier hotel facilities to establish NNI interconnections with other service providers also located inside these collocation facilities. A carrier hotel, also called a collocation center, is a secure physical site or building where data communications media converge and are interconnected for economy of scale reasons. It is common for numerous service providers to share the facilities of a single carrier hotel. Interconnection between service providers in such a collocation or carrier hotel facility is completed by physically cross-connecting a copper or fiber network connection from one service provider to a network connection from another service provider using the cross-connect panel in the “Meet Me” room of the collocation or carrier hotel provider. The “Meet Me” room is an area of the collocation facility dedicated for all the tenants in the building to interconnect or meet to exchange connections.

In FIG. 2, for example, service provider B 203 renting space in a carrier hotel 200 needs to establish interconnection with service provider A 201, also collocated in the carrier hotel 200. To accomplish this interconnection, service provider A 201 extends a network connection 202, e.g., fiber optic cable, from its network equipment located in its space in the carrier hotel 200 to the “Meet Me” room 204 where it is connected physically to a patch panel (PA) 206 (which sits on a cross connect panel (CC) 208). Service provider A 201 is then connected to service provider B 203 via a jumper wire 210 between service provider A's patch panel 206 and service provider B's patch panel 212. Service provider B 203 then extends a network connection 214 from the “Meet Me” room 204 to service provider B's network equipment located in the carrier hotel 200. If the service provider B 203 then needs to establish interconnection with a service provider C 205, also located in the carrier hotel, the service provider B 203 must again extend a network connection 216 to another slot on its patch panel 212 in the “Meet Me” room to be connected via the jumper wire 214 to provider C's patch panel 216 where the service provider C 205 has a network connection 218 running between the “Meet Me” room and service provider C's network equipment located in the carrier hotel 200.

While this effort potentially creates a physical bonding between the service providers, this physical cross-connection is on a one to one service provider basis, thus not offering scalability to reach more than one service provider through a single connection; moreover, just establishing a physical bond is almost always insufficient to allow end-to-end Ethernet Service connectivity between the providers. Since each provider has a unique Ethernet Service definition, the configuration on one or both switches must be changed to remap one service definition to the other. For example, one provider may offer three levels of service quality while the other offers two. Unless the configuration is adjusted to map between these two providers, the end-to-end service will not perform as expected. Moreover, changing such configurations causes considerable work on the part of the provider; testing these configurations, training staff, updating procedural documents and updating Operational Support Systems.

While most collocation or carrier hotels do not provide interconnection functions beyond their “Meet Me” cross-connect panels, a limited number of collocation centers do provide some in-facility networking to enable one service provider in the facility to reach other service providers for interconnection purposes. In such a collocation facility, a network is created within the facility using switched technology such as a fast Ethernet or ATM. This networking allows two service providers to connect through the switched circuit. Such simple intra-facility functionality does reduce the number of costly physical connections but offers little to address the Ethernet Service Mapping challenges. This approach also requires that the two service providers interconnecting using this intra-facility network must both be renting space in the carrier hotel.

Further, even if some transaction and physical interconnections were made, Ethernet carriers need to establish a manner of measuring and monitoring Ethernet services they provide. Again, each Ethernet carrier has different systems and equipment for measuring quality of service, so it is complex to do so across a large number of carriers and does not scale well. Finally, even if interconnections are achieved and monitoring is employed, there are differences between each carrier's system and process for querying service, building inventory, quotations, ordering, fulfillment, service legal agreement (SLA) reporting, trouble sectionalizing, and billing harmonizing. Thus, bonding these systems would not increase efficiency between carriers.

Finally, there is a significant challenge associated with Service Quality Monitoring. A service provider typically offers a set of SLAs to the Enterprise customer to whom they are selling the service. When one of the endpoints of this service is “off-net” and the Service Provider must go through another provider to access to this endpoint, the Service Provider must find a mechanism to measure the service quality off-net. Most typically today, the method to do so requires that the provider places a Network Interface Demarc (NID) device on the off-net customer premises. This is very costly, both because of the cost of this device but also in the fact that the service provider generally does not have people to do installation, support and repair of these devices in every off-net region.

### SUMMARY OF THE INVENTION

The present invention is intended to solve the above-noted business and technical problems by establishing an independent, common service provider interconnection platform with advanced switching capabilities and centralized monitoring to enable the rapid, efficient provisioning of Carrier Ethernet services between multiple service providers' networks. This invention both facilitates standards based, scalable Carrier Ethernet interconnection while also enabling service providers with incompatible services to readily interconnect through the use of advanced, proprietary network management capabilities.

One embodiment of the invention is directed to a communications system configured for enabling a plurality of service providers to interconnect via an Ethernet platform, the plurality of service providers employing disparate Ethernet protocols. The system includes a central server and a plurality of switching locations. Each one of the plurality of switching locations is communicatively connected to the central server and to the plurality of service providers. Each of the plurality of switching locations includes a plurality of Ethernet router switches, a monitoring device, a local server coupled to a plurality of databases. Each of the plurality of databases is associated with each of the service providers. A communications media is provided for interconnecting the plurality of switches, the service providers, the router switches, the connectivity device, and the local server. The system enables the service providers to be interconnected on the Ethernet platform by establishing protocol mappings between any two Ethernet protocols associated with corresponding service providers.

In one aspect of the invention, the central server comprises a customer presentation module, a management module for managing the plurality of Ethernet router switches, a service module for monitoring Ethernet services, collecting and analyzing service data, and a centralized service database for storing information associated with the plurality of service providers. The customer presentation module, the management module, the service module, the centralized service database are communicatively connected through a local interface.

Another embodiment of the invention is directed to a method for facilitating interconnections between a plurality of communication service providers through an

Ethernet switching platform. The method includes establishing a connection between each of the plurality of service providers and the Ethernet switching platform, the plurality of service providers employing disparate Ethernet protocols, determining each of the Ethernet protocols associated with each of the plurality of service providers, and establishing protocol mappings between any two Ethernet protocols for facilitating interconnections between corresponding service providers.

### BRIEF DESCRIPTION OF THE DRAWINGS

For a better understanding of the invention, reference may be had to preferred embodiments shown in the following drawings in which:

FIG. 1 illustrates a typical network of NNI connections;

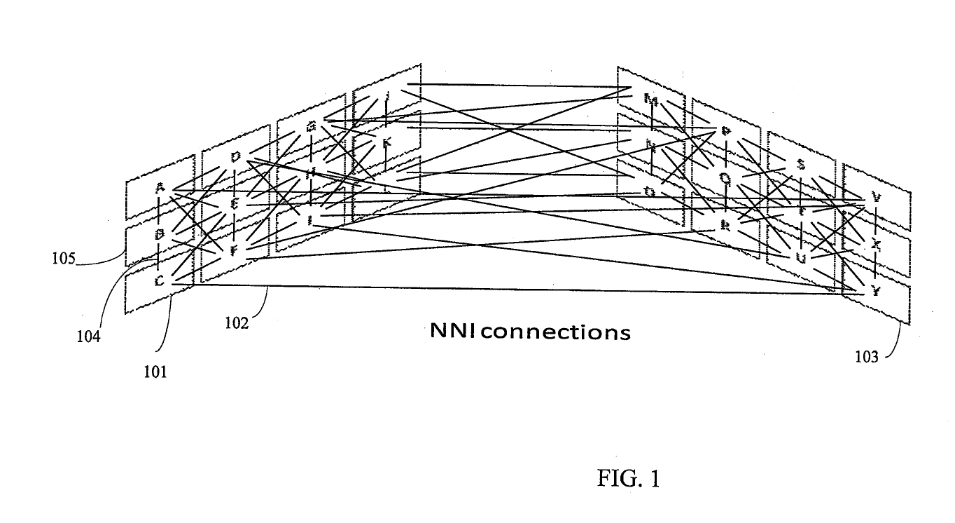

FIG. 2 illustrates a carrier hotel for multiple carriers;

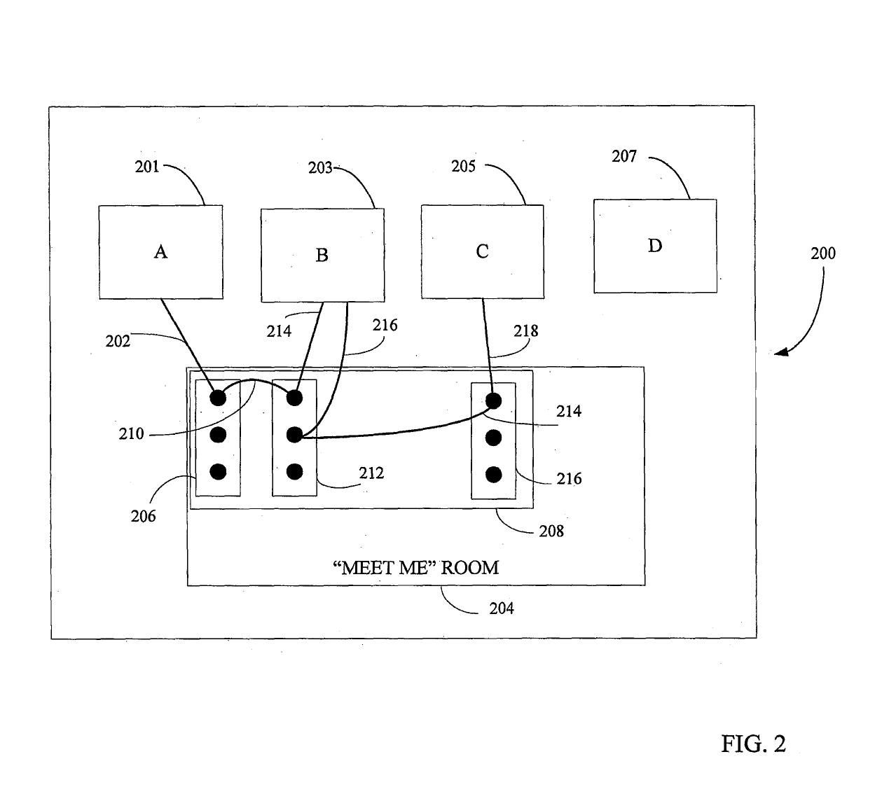

FIG. 3 illustrates an interconnection platform for connecting a group of service providers in accordance with the present invention;

FIG. 4 illustrates one of the service providers shown in FIG. 3 who is also connected to the interconnection platform via a dual fiber connection;

FIG. 5 illustrates a virtual or logical Ethernet connection on the interconnection platform shown in FIG. 4 with various service providers connected over the same physical connection;

FIG. 6 illustrates a service provider passing traffic through the platform switch to another service provider over one of the service provider's physical connections to the interconnection platform shown in FIG. 4;

FIG. 7 illustrates a network analysis functionality through a compatibility matrix;

FIG. 8 illustrates two service providers interconnected via physical connections to the platform shown in FIG. 4;

FIG. 9 illustrates an embodiment of a monitoring node configured to monitor Ethernet services via a network traffic probe connected to the platform switch;

FIG. 10 is a block diagram illustrating an embodiment of a networked computing system in accordance with the principles of the present invention; and

FIG. 11 is a block diagram of one form of a computer or server of FIG. 3 and/or FIG. 10, having a memory element with a computer readable medium for implementing the platform system in accordance with the present invention.

### DETAILED DESCRIPTION OF PREFERRED EMBODIMENTS

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

A preferred embodiment of the present invention provides a first service-level interconnect platform designed to join disparate service provider networks in order to enable end-to-end Carrier Ethernet across service providers' networks. Conventionally, an expansion of Carrier Ethernet has been constrained, limited to the islands of connectivity largely contained wholly within individual service provider's networks. In accordance with the present invention, a new Carrier Ethernet service-level interconnect platform is provided to integrate platform components into defined interfaces to solve the pressing need for ubiquity—the problem of each service provider needing to connect to all other service providers in order to make Carrier Ethernet widely available. The platform comprises three key elements:
A set of Platform Switching Locations (PSL) at numerous geographic locations where traffic between Providers is connected, translated, and monitored;
A set of central systems used to interconnect these PSLs and integrate with

Provider Systems; and
A set of unique processes built around these systems to make it work in the context of multiple carrier processes.

Unlike existing interconnect services described above, which provide simple, physical, local cross-connect or intra-facility networking, the present invention plays an integral role in enabling the delivery of Carrier Ethernet across disparate networks by actively participating in service interworking, harmonizing virtual bandwidth profiles, enabling different classes of service, delivering address scheme mapping, performing end user-to-end user monitoring, performing service inventory with logical organization of inter-carrier data, providing common normalized machine interfaces with adapters to existing interfaces between diverse operating systems, and providing a unique central “Marketplace” to help with the integration between buying and selling service provider processes and systems.

### Physical Connection Services

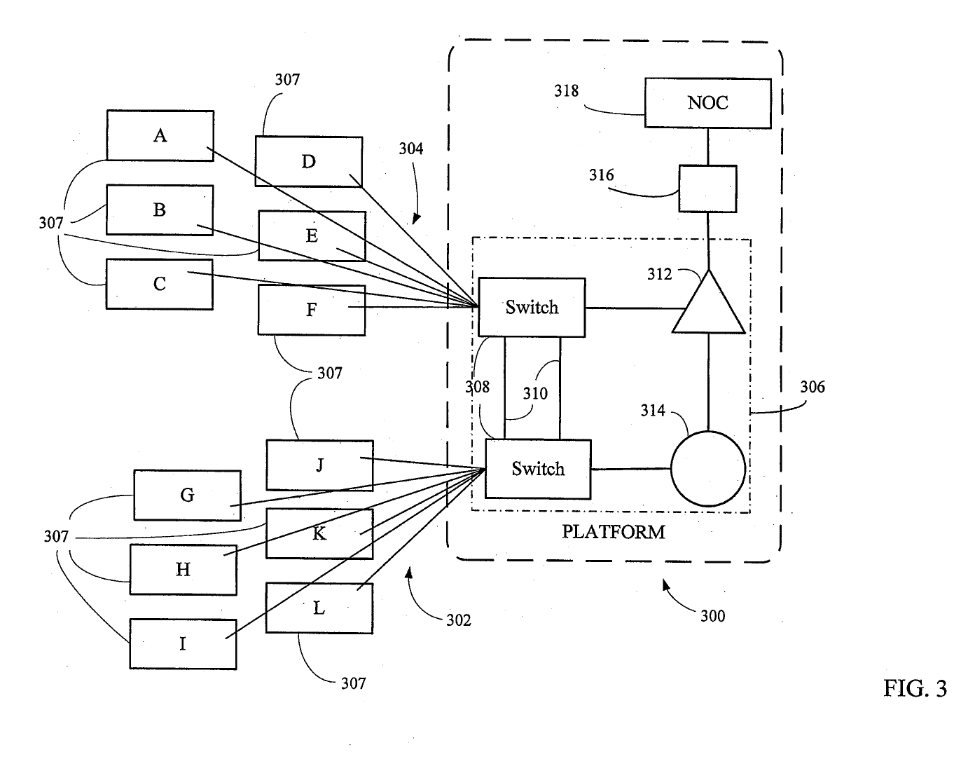

Now referring to FIG. 3, a preferred embodiment of a platform 300 in accordance with the present invention establishes physical connections 302 and 304 between a platform switching location (PSL) 306 and the connecting service providers A-L 301. As shown in FIG. 3, the PSL 306 may contain, for example, two or more Ethernet router switches 308, such as the Cisco ASR 9000 Series or ALU 7750 series, which are connected to each other with a network cable or cables 310, testing equipment 312 to monitor end-to-end connectivity, servers 314 for packet analysis to diagnose troubles or communication issues on the end-to-end service, and connectivity equipment 316 for remotely monitoring the PSL 306 from a centralized network operations center (NOC) 318. The switches 308 and servers 314 associated with the PSL 306 are essentially computing devices, such as microprocessors, configured or programmed with instructions to make substantially instantaneous decisions by constantly gathering information regarding all the connected networks to keep service in the required service quality range and to switch automatically in microseconds to a backup switch or equipment if necessary to avoid an outage. In other words, each of the terms “switch” and “server” refers to a microprocessor operating computer software that is configured to perform the corresponding software tasks described herein. The servers 314 and switches 308 also provide output, reporting on the status of the networks, equipment and services in order, for example, for the service providers 301 to be updated on the status of the services traversing the PSL 306.

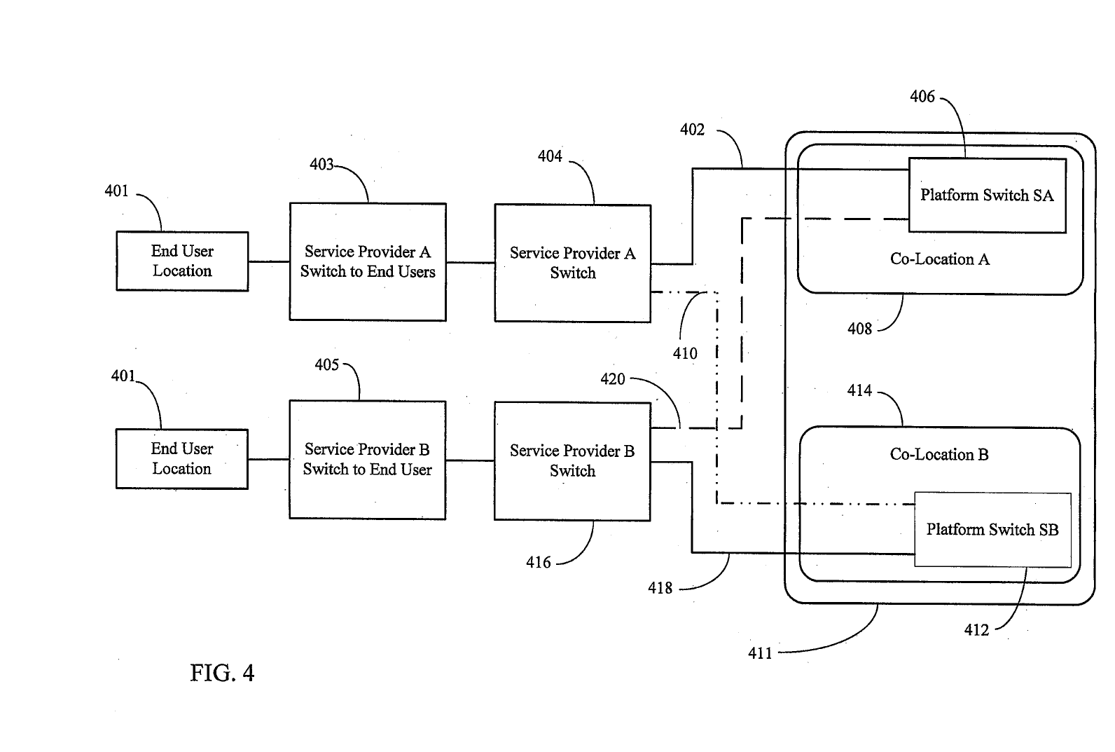

Now referring to FIG. 4, an exemplary embodiment 400 of the physical connections between the PSL 306 and the service providers 301 of FIG. 3 is provided, which can vary based on capacity (e.g., 1, 10 or 100 gigabit Ethernet fiber connections) and redundancy (e.g., single or dual fiber connections). In FIG. 4, these connections can occur, for example, by extending a fiber optic connection 402 from service provider A's network switch 404 to the platform switch SA 406 of the PSL 411 located in co-location area A (CLA) 408 and extending a second fiber optic connection 410 from service provider A's network switch 404 to the platform switch SB 412 located in co-location area B (CLB) 414. This method creates a dual fiber connection, which is fault tolerant even in the event of the complete failure of either platform switch SA 406 or platform switch SB 412. Moreover, since platform switch SA 406 and platform switch SB 412 can be in different nearby locations, it allows for protection of catastrophic failures at either of the two locations. This process of physically connecting a service provider switch to the platform 300 can then be repeated for each service provider seeking to utilize the platform 300. Of course, once a service provider has established a physical connection to the PSL 411, it has the ability to be interconnected with every other service provider interconnecting with the PSL 411 without having to establish separate physical connections with each such service provider.

As a result, the platform 300 helps resolve the N² Problem, by enabling rapid interconnection among service providers with the fewest number of total connections.

For example, FIG. 4 shows that service provider B is also connected to the PSL 411 from its switch 416 using dual fiber connections 418 and 420. Service provider B's active connection 418 is with the platform switch SA 406, with connection 420 serving as the standby connection to switch SB 412.

### Virtual Service-Level Interconnect

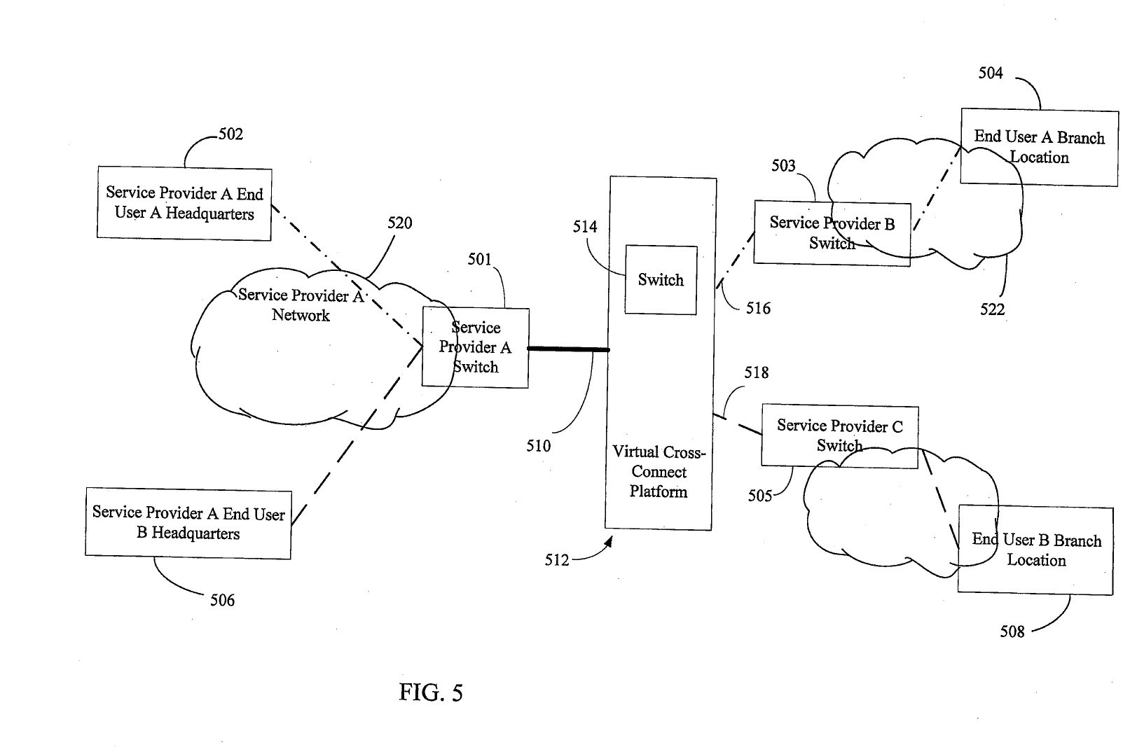

Once physical connections are established with the PSL 411, multiple virtual transport connections can be configured from the central location of the platform 300 between various service providers without any physical changes to the PSL 411. One example of such an embodiment is shown in FIG. 5. Service Provider A 501 is seeking to establish end to end Carrier Ethernet connectivity between end user A's headquarters location 502 and its branch office location 504; in addition, service provider A 501 is seeking to establish end to end Carrier Ethernet connectivity between end user B's headquarters location 506 and its branch office location 508. The branch office locations 504 and 508 of both end users A and B are outside of the territory served by service provider A, and therefore require interconnection with service providers that can provide the service to the branch locations 504 and 508.

To interconnect with the service providers—service provider B switch 503 and service provider C switch 505—that can reach the two end users' branch locations 504 and 508, service provider A switch 501 can utilize its single, physical connection 510 to the PSL 512. The platform switch 514 configures or provisions between service provider A's physical connection 510 and the physical connections 516 and 518 of service provider switch B 503 and service provider switch C 505 multiple dedicated Ethernet virtual connections (EVCs) conforming to the Carrier Ethernet service profiles required by each of service provider A's end users. Ethernet virtual connections (EVC) are a connection between two end user network interface devices (UNIs), which are the devices located at the edge of a service provider's network between the network and the end user, that appear to be a direct and dedicated connection, but is actually a group of logic circuit resources from which specific circuits are allocated as needed to meet traffic requirements in a packet switched network. In this case, two network devices can communicate as though they have a dedicated physical connection. These virtual connections established on the PSL 512 are then mapped to or associated with virtual connections existing between the PSL 512 and each service provider's network 520 and 522, thus establishing a complete end to end virtual connection between each end user's headquarters location 502 and 506 and branch locations 504 and 508. As such, one EVC AB is comprised of three parts; a part that is through the service provider A network 520, a part that is across the PSL 512, and a part through the service provider B network 522. Another EVC AC is also composed of three parts; a part that is through the service provider A network 520, a part that is across the PSL 512, and a part through the service provider C network 524. The key is that the part of each of these EVCs AB and AC that goes through the exchange PSL 512 is not only establishing connectivity, but also remapping to allow the end-to-end services to work.

The interconnection PSL 512 can be utilized as well to interconnect service provider networks together using Carrier Ethernet not to serve an end user, but to merely exchange traffic between the service providers needing to terminate with one another.

For example, a service provider may have Internet data traffic terminating to a web address hosted by another service provider. Alternatively, a service provider may have voice traffic that needs to terminate to the network of another service provider. Instead of utilizing legacy Time Division Multiplexing (TDM) based interconnection facilities, which are much less efficient than Carrier Ethernet but have the benefits of years of standardization, the service providers could utilize the interconnection PSL 512 to implement Carrier Ethernet connectivity between their networks to terminate such traffic without the costs and expense of putting an NNI in place between their networks. As known to one of ordinary skills in the art, TDM is a technique of transmitting multiple digitized data, voice, and video signals simultaneously over one communication media. TDM is the predominant legacy transmission standard in the world.

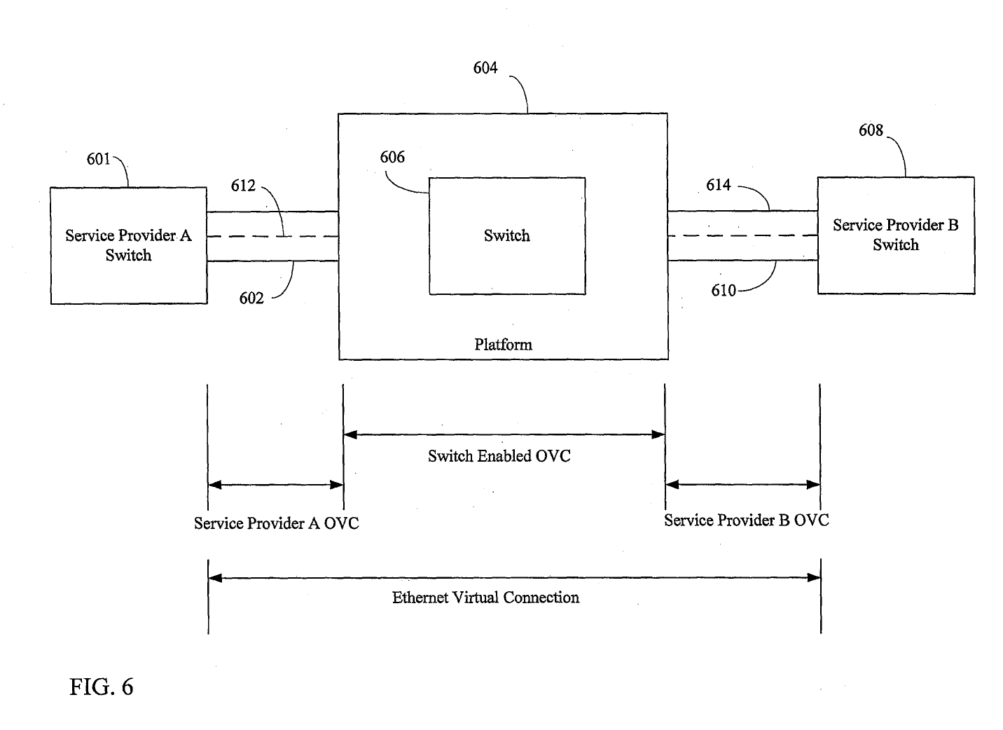

Now referring to FIG. 6, a service provider A's switch 601 utilizing its physical connection 602 to the PSL 604 to pass traffic through the platform switch 606 to service provider B's switch 608 over service provider B's physical connection 610 to the PSL 604. Just as described above, this traffic could flow over virtual connections mapped across service provider A's network 612, the PSL 604, and service provider B's network 614 to establish end-to-end Carrier Ethernet conforming to the required service profiles. As noted previously, Carrier Ethernet standards are necessary when carriers seek to utilize Ethernet technology but require high service quality performance with measureable and defined parameters (e.g., delay, availability, jitter) versus the prior art “best efforts” Ethernet interconnection.

### Platform Interconnection Functions

In accordance with the present invention, the disclosed platform 300 can be configured not just to facilitate interconnection between two service providers, to address the N² Problem above, but also to analyze and harmonize variances between discrete service offerings of the two service providers in order to align the individual service of one service provider to the required prescribed service profile of the other service provider in order to deliver end-to-end Carrier Ethernet service.

Network and Service Analysis

To facilitate rapid, efficient interconnection, processes are put in place to analyze and test all interconnected service provider networks and service definitions at a very detailed level.

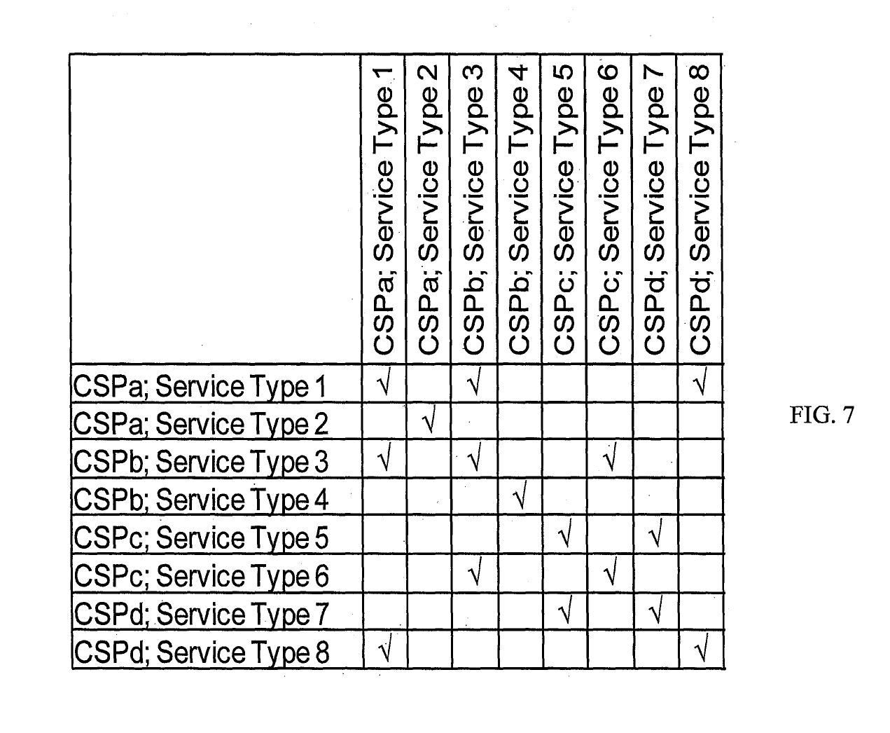

This network analysis process would obviate the need for each service provider to perform such network profiling for every other service provider they plan to interconnect with. When, for example, a service provider seeks to purchase service from three different network operators, the network analysis functionality embedded into the platform 300 would remove the need for the service provider to analyze and test the disparate network protocols (e.g., frame size, frame rate, etc.) of the three different networks. Instead, the analysis performed in conjunction with the platform 300 is used to determine feasibility of service interconnect between these providers and determination is made on how to do these interconnects without requiring the service provider to change their service definition or do extensive interconnect testing. Because the platform 300 understands how to map communication protocols and service definitions between all of the connected service providers, the process of profiling those service providers' networks would be eliminated for all future service providers who connect to the platform 300. As a result, the platform 300 is configured to create an efficient, scalable solution for network interconnection by eliminating this burdensome step, thus mitigating the N² Problem described above. FIG. 7 demonstrates the network analysis functionality through a compatibility matrix which shows which service types from various service providers connected to the platform 300 can be successfully interconnected consistent with the required service parameters. The matrix would be populated by platform personnel using proprietary algorithms who have studied the unique service definitions of the different service provider services.

Service Harmonizing

Beyond mapping Ethernet Frames to allow interconnect, the platform 300 can help end-to-end Carrier Ethernet quality of service (QOS) across the service provider networks connected to the PSL 604, the platform switch 606 can, through the creation and implementation of proprietary algorithms together with the PSL switch 606, provide additional traffic management of services between service providers. This traffic management may include custom traffic shaping to match, for example, the burst sizes between two different service providers' unique traffic profiles while controlling packet loss in order to deliver the required performance of the end-to-end service. This traffic shaping function actually involves the PSL 604 transforming the data from the shape in which it was delivered to the PSL 604 by one service provider to a new shape compatible with the required parameter of the other service provider.

For example, consider a service crossing Carrier A and Carrier B. Both providers have the ability to support a sustained rate of 10 Mb/s but Carrier A supports a burst size of 50 frames, whereas Carrier B supports a burst of 25 frames. If the user injects a burst of 50 frames at line rate, then stops transmitting, this traffic will be successfully transmitted across Carrier A's network. However as soon as the traffic reaches Carrier B's network, 25 frames would be dropped as it exceeds Carrier B's Committed Burst Size. This would cause intermittent and unpredictable frame loss across the end-to-end circuit. With the disclosed PSL 604 inserted between Carrier A and Carrier B, the PSL 604 is aware of the differing burst size and is configurable to actively shape the traffic so that this frame loss does not occur. In short, it would be configured to absorb the full burst from Carrier A and shape the traffic over time into the network of Carrier B so that Carrier B never hits its burst limit.

The harmonization functionality of the platform 300 contributes to mitigating the N² Problem. In the example described above (a service provider seeking to buy service from three different network operators), the harmonization functionality eliminates the need for the service provider to implement its own switch and to develop its own set of shaping algorithms. And this effort would have to be repeated by the next service provider that seeks buy services from those same network operators. Instead, the service providers and network operators all plug into the PSL switch 606 where a single set of algorithms performs the network harmonization. As a result, network harmonization through the platform 300 is more efficient and scalable than each interconnected network having to put in place infrastructure and harmonization functionality for every other interconnected network.

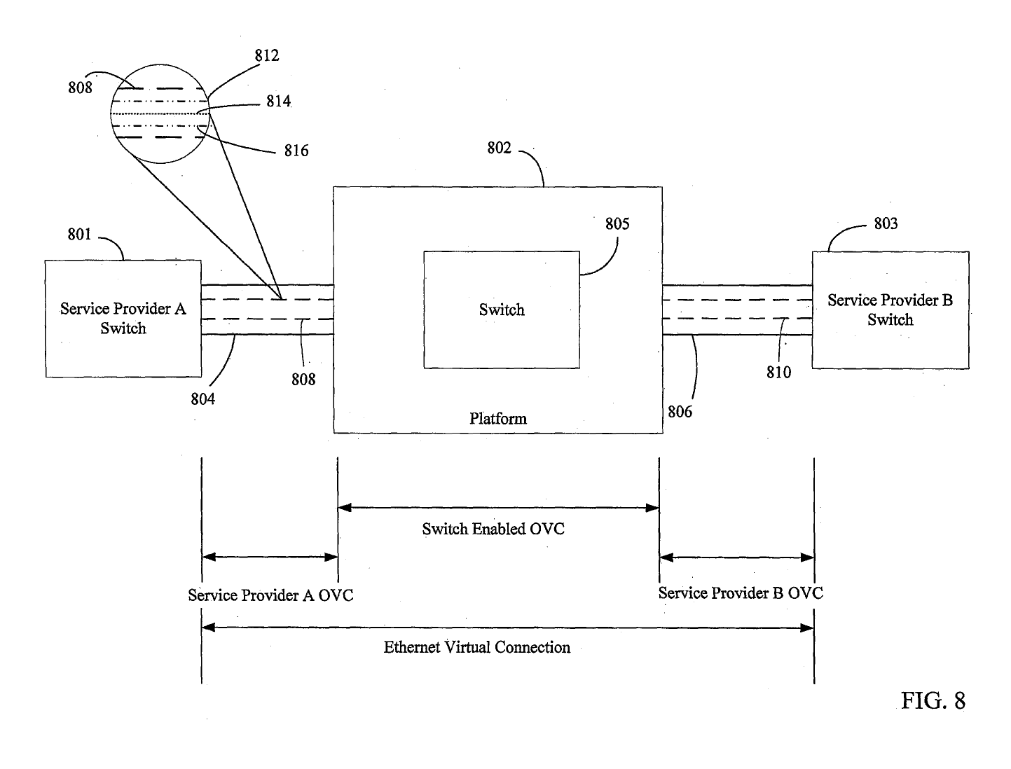

The platform 300 can also enable multiple classes of service to be delivered over a single EVC. In one exemplary embodiment, FIG. 8 shows two service providers A 601 and B 603 already interconnected to the PSL 802 over physical connections 804 and 806. Each service provider A 801 and B 803 and the PSL 802 can then establish an EVC to enable Carrier Ethernet service between the service providers' switches A 801 and B 803. If the service providers A 801 and B 803 require more than one type of discrete class of Carrier Ethernet service to be provided between their switches, for example one class of service designed for real time video and the other class of service suitable for voice communications, the service providers A 801 and B 803 could re-use not only the existing physical interconnections 804 and 806 with the platform 802, but also the same connections 808 and 810 to provide a second unique class of Carrier Ethernet service over the same connection. As illustrated in FIG. 8, an exploded view of the connection 808 can comprise multiple service classes 812, 814, and 816 over a single connection. This would be enabled by the PSL 802 providing the tagging and mapping functionality of the two classes of service, for example, across the interconnected connection 808. Tagging is used to identify packets travelling through a network. When an Ethernet frame traverses, for example, a trunk link, a special virtual local area network (VLAN) tag is added to the frame and sent across the trunk link. As the frame arrives at the end of the trunk link, the tag is removed and the frame is sent to the correct access link, so that the receiving end is unaware of any VLAN information. As known to one of ordinary skills in the art, VLAN is a group of devices on one or more LANs configured so that they can communicate as if they were attached to the same wire, when in fact they are located on a number of different LAN segments.

Finally, the platform 300 can support distant Ethernet LAN (E-LAN) services and advanced tunneling schemes. E-LAN services use multipoint-to-multipoint EVCs to enable a virtual LAN-like service over a wide area. Network tunneling refers to the ability to be able to carry a payload over an incompatible network, or provide a secure path through an untrusted network. Virtual Private Networks (VPN) are accomplished via network tunneling.

### Service Analysis

Located at each PSL 802 are servers (not shown in FIG. 8), such as servers 314 of FIG. 3, capable of doing deep packet inspection and analysis. In the case of any difficult to diagnose troubles between providers interconnecting, the PSL 802 can be set up to mirror frames to one of these servers. This allows extremely detailed analysis of the packet flow across a particular service so that complex troubleshooting can be performed much more quickly and cost effectively as this analysis can be performed without sending resources out to site.

Service Monitoring

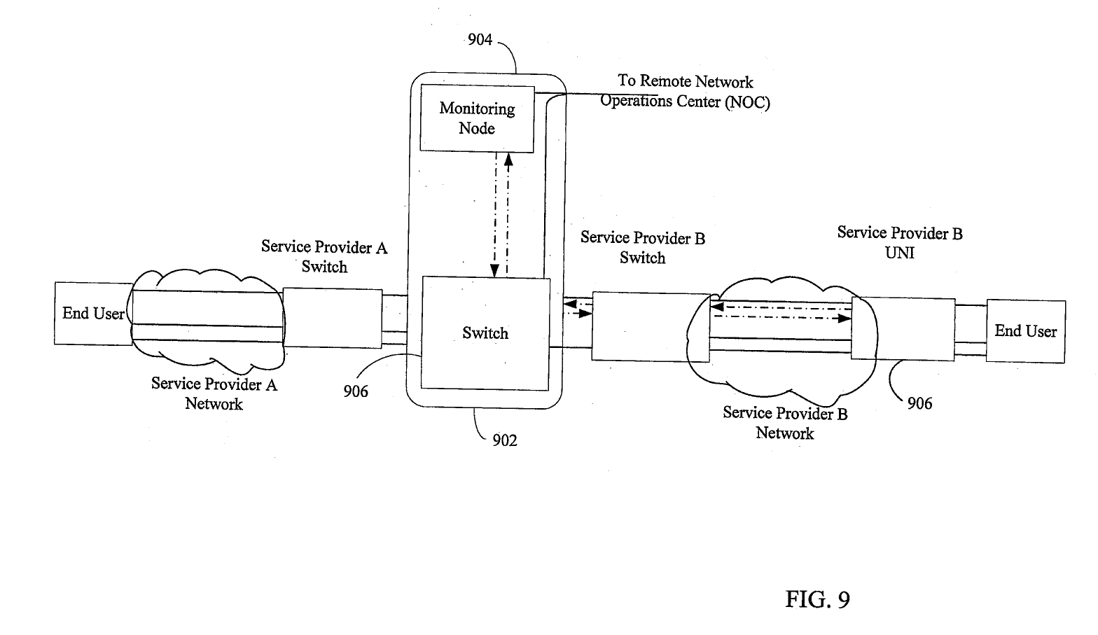

The platform 300 is configured to enable a unique monitoring service that assists service assurance, enables virtual connection troubleshooting, and saves the costly and complex deployment of multiple network interface devices (NID) on end users' premises. This monitoring service is also intended to enable industry standard service-level visibility of service providers' networks, thereby augmenting and enhancing the service providers' service offerings to their end users. As shown in FIG. 9, the platform's service monitoring is enabled in the PSL 902 by the presence of a monitoring node 904, which is a network traffic probe communicatively coupled to the platform switch 906. The monitoring node 904 is configured to generate synthetic traffic sent to the service provider's UNI 905 that returns to the monitoring node 906, where multiple parameters per EVC (service) are summarized and sent to a central database for analysis and reporting. Such a monitoring service can enable an apples-to-apples comparison of quality of service (e.g., frame loss, availability, delay, and jitter) across service providers regardless of differing technologies between providers. The resulting monitoring reports will be independent of which service provider is providing the EVC to the end user location. As a result, a service provider connected to the PSL 902 can receive a consistent (normalized) set of reports regardless of which interconnected service provider is involved in providing the connection to the end user.

Moreover, in the event that the service quality degrades below a set threshold for any of the following measurements, personnel managing the PSL 902 can be notified in real-time allowing them to proactively contact both buying and selling service providers to take remedial action:
Delay—the time taken for service frames to travel across a network; delay is measured from the arrival of the first bit at the ingress UNI to the output of the last bit of the egress UNI.
Delay Variation—the variation in delay for a specified number of frames.
Frame Loss Ratio—a measure of the number of lost frames between the ingress UNI and the egress UNI. Frame Loss Ratio is expressed as a percentage.
Availability—A measure of the percentage of time that a service is useable.

By contrast, if a service provider establishes separate NNIs with a number of other service providers, each service provider it interconnects with will most likely use different mechanisms to measure the service quality of their networks, providing numerous unique set of reports and no mechanism to proactively notify on service degradation. This would make service quality monitoring and comparisons between the service providers difficult and less efficient.

### Carrier Ethernet Marketplace

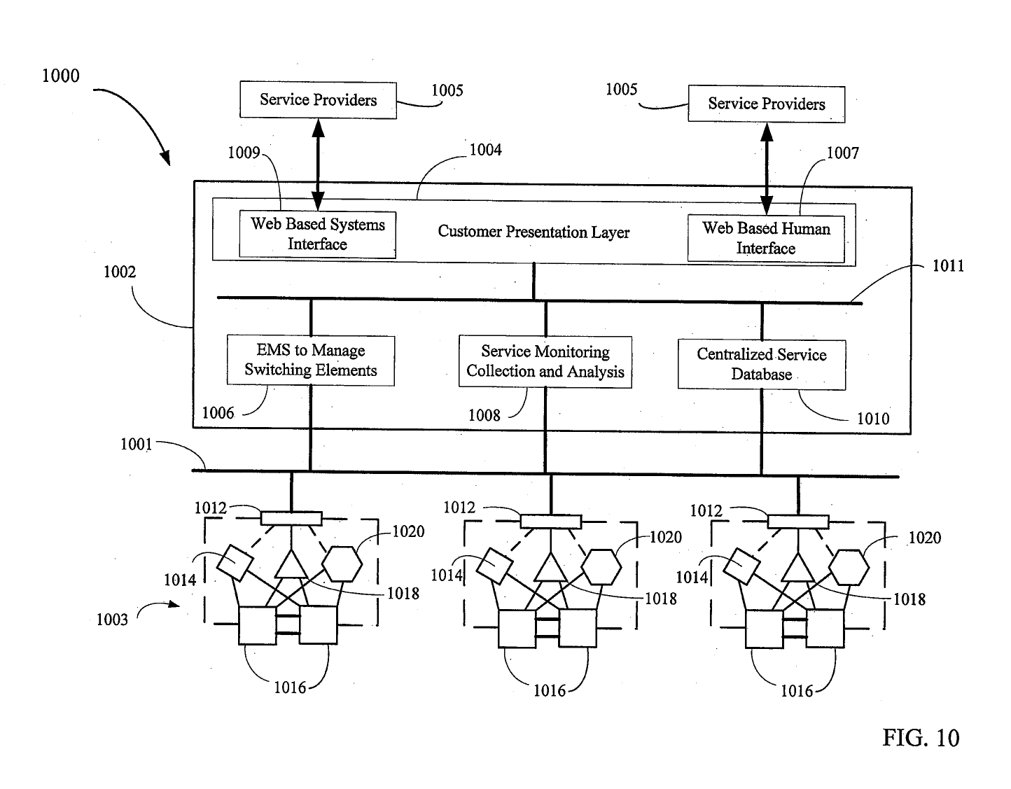

In accordance with the present invention, an exchange control system 1000 is provided to facilitate process and system interactions between buying and selling service providers connected to the platform. As shown in FIG. 10, the exchange control system 1000 comprises a data center 1002 communicatively coupled with a plurality of exchange point of presences 1003, via communications carrier 1001 supporting Ethernet/LP, and with service providers 1005 via secure northbound interfaces (NBI) for integration with their telecommunication operating support systems (OSS). The data center 1002, which is preferably a centralized center, includes a customer presentation layer or module 1004, an Ethernet management services (EMS) module 1006 configured for managing switching elements or components, a service module 1008 for monitoring Ethernet services, collection and analysis of service data, and a service database 1010 for storing information related to service providers and services established with them, all in communication with one another through a local interface 1011. The customer presentation layer 1004 includes Web based human interfaces 1007, which enable users associated with the service providers to interact, as well as Web Services interfaces 1009, which enable systems associated with the service providers to interact. Each of the plurality of exchange point of presences 1003 includes a management routing module or router 1012, a customer traffic examination and analysis (packet sniffer) module 1014, traffic switching and mapping module 1016, a service testing traffic injection hardware module 1018, and a service monitoring traffic injection hardware module 1020. For improved reliability of services provided by the control system 1000, all components and communication paths are redundant.

As configured, the control system 1000 supports the above discussed unique central Marketplace, which can provide the following capabilities:
Sellers are provided with the ability to advertise the geographic building addresses to which they can deliver Ethernet services and the attributes of these Ethernet services, including:
   Service names,
   classes of service,
   SLA guarantees offered
   Asset type (owned asset, resold, etc)
   Guaranteed install times
   Notes associated with special construction, etc.
Buyers are provided with the ability to search for geographic addresses to locate if it can be served by any of the Sellers connected to the Platform, and if so, all of the above service details. This access to the platform's Marketplace will enable rapid matching and exchange of information for service providers seeking to work together to establish end-to-end Carrier Ethernet service.
Buyers and Sellers will be provided with the ability to see a detailed service inventory of all of the services that they are buying and selling via the exchange along with detail on how these services are configured to interwork, contact information between providers, service monitoring thresholds on these services, etc.
Buyers and Sellers will be provided with the ability to see a near-real time operational state of all of the monitored service components and to extract historical monitoring SLAs for these components.
Buyers and Sellers will be provided with the ability to order connections, change connections and delete connections which can flow through to the PSL without human intervention.

All of the above are done in such a way to ensure security and control to see only information for which this user is authorized to see.

Although in the above discussion of the Ethernet platform 300, members, i.e., service providers and purchasers, of a communication exchange can connect only with other members connected to the same exchange; the Ethernet platform 300 also enables members connected to one communication exchange to reach buildings served by members connected to a different exchange. This connection arrangement between members of different exchanges can be accomplished by a number of ways, such as:
The platform 300 can be augmented by acquiring bandwidth from long-haul providers connecting the different exchanges.
Transport providers can be recruited to sell exchange interconnect services, in addition to access services, to participating exchange members of different exchanges.
Transport providers can be recruited to bundle inter-exchange operator virtual connections (OVCs) with access provider's OVC and sell the complete communication solution to Ethernet service buyers.

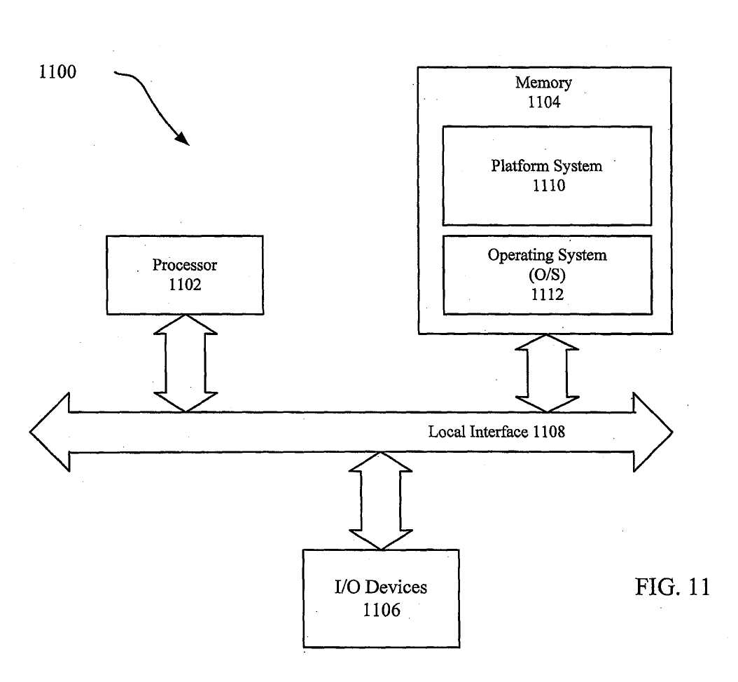

FIG. 11 is a block diagram of a computer 1100. The computer 1100 may be the platform server 314 of FIG. 3, or any computer associated with the platform 300 of FIG. 3 and its components. The computer 1100 may include a memory element 1104. The memory element 1104 may include a computer readable medium for implementing the system and method for implementing an independent, service provider interconnection platform with advanced switching capabilities and centralized monitoring to enable rapid and efficient provisioning of Carrier Ethernet services between multiple service provider networks.

The platform or PSL system 1110 may be implemented in software, firmware, hardware, or any combination thereof. For example, in one mode, the platform system 1110 is implemented in software, as an executable program, and is executed by one or more special or general purpose digital computer(s), such as a personal computer (PC; IBM-compatible, Apple-compatible, or otherwise), personal digital assistant, workstation, minicomputer, mainframe computer, computer network, “virtual network” or “internet cloud computing facility”. Therefore, computer 1100 may be representative of any computer in which the platform system 1110 resides or partially resides.

Generally, in terms of hardware architecture, as shown in FIG. 11, the computer 1000 includes a processor 1102, memory 1104, and one or more input and/or output (I/O) devices 1006 (or peripherals) that are communicatively coupled via a local interface 1108. The local interface 1108 may be, for example, but is not limited to, one or more buses or other wired or wireless connections, as is known in the art. The local interface 1108 may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor 1102 is a hardware device for executing software, particularly software stored in memory 1104. Processor 1102 can be any custom made or commercially available processor, a central processing unit (CPU), an auxiliary processor among several processors associated with the computer 1100, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. Processor 1002 may also represent a distributed processing architecture such as, but not limited to, SQL, Smalltalk, APL, KLisp, Snobol, Developer 200, MUMPS/Magic.

Memory 1104 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 1104 may incorporate electronic, magnetic, optical, and/or other types of storage media. Memory 1104 can have a distributed architecture where various components are situated remote from one another, but are still accessed by processor 1102.

The software in memory 1104 may include one or more separate programs. The separate programs comprise ordered listings of executable instructions for implementing logical functions. In the example of FIG. 11, the software in memory 1104 includes the platform system 1110 in accordance with the present invention, a suitable operating system (0/S) 1112. A non-exhaustive list of examples of suitable commercially available operating systems 1112 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system 1112 essentially controls the execution of other computer programs, such as the platform system 1110, and provides scheduling, input-output control, file and data management, memory management, and communication control and related services.

The platform system 1110 may be a source program, executable program (object code), script, or any other entity comprising a set of instructions to be performed. When a “source” program, the program needs to be translated via a compiler, assembler, interpreter, or the like, which may or may not be included within the memory 1104, so as to operate properly in connection with the O/S 1112. Furthermore, the platform system 1110 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, .Net, HTML, and Ada. In one embodiment, the platform system 1010 is written in Java.

The I/O devices 1106 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices 1106 may also include output devices, for example but not limited to, output modules for PLCs, a printer, bar code printers, displays, etc. Finally, the I/O devices 1106 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

If the computer 1100 is a PC, workstation, PDA, or the like, the software in the memory 1004 may further include a basic input output system (BIOS) (not shown in FIG. 3). The BIOS is a set of essential software routines that initialize and test hardware at startup, start the 0/S 1112, and support the transfer of data among the hardware devices. The BIOS is stored in ROM so that the BIOS can be executed when computer 1000 is activated.

When computer 1100 is in operation, processor 1102 is configured to execute software stored within memory 1104, to communicate data to and from memory 1104, and to generally control operations of computer 1100 pursuant to the software. The platform system 1110, and the O/S 1112, in whole or in part, but typically the latter, may be read by processor 1102, buffered within the processor 1102, and then executed.

When the platform system 1110 is implemented in software, as is shown in FIG. 11, it should be noted that the platform system 1110 can be stored on any computer readable medium for use by or in connection with any computer related system or method, although in one preferred embodiment, the platform system 1110 is implemented in a centralized application service provider arrangement. In the context of this document, a computer readable medium is an electronic, magnetic, optical, or other physical device or means that can contain or store a computer program for use by or in connection with a computer related system or method. The platform system 1110 can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the platform system 1110 is implemented in hardware, the platform system 1110 may also be implemented with any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Although exemplary embodiments of the invention have been described in detail above, those skilled in the art will readily appreciate that many additional modifications are possible in the exemplary embodiment without materially departing from the novel teachings and advantages of the invention. Accordingly, these and all such modifications are intended to be included within the scope of this invention.

We claim:

1. A communications system for enabling a plurality of service providers to interconnect via an Ethernet platform, the plurality of service providers employing disparate Ethernet protocols, the system comprising:
a central server; and
a plurality of switching locations, each one communicatively connected to the central server and to the plurality of service providers, wherein each of the plurality of switching locations includes a plurality of Ethernet router switches, a monitoring device, a local server coupled to a plurality of databases, each of the plurality of databases associated with each of the service providers, and a communications media for interconnecting the plurality of switches, the service providers, the router switches, the connectivity device, and the local server, and
wherein,
the system enables the service providers to be interconnected on the Ethernet platform by establishing protocol mappings between any two Ethernet protocols associated with corresponding service providers.

2. The communications system of claim 1, wherein each of the plurality of switching locations is a protocol neutral platform switching location.

3. The communications system of claim 1, further comprising:
a plurality of connectivity devices for connecting each of the plurality of switching locations to the central server.

4. The communications system of claim 1, wherein each of the service providers comprises at least one router switch communicatively connected to one of the router switches of one the plurality of switching locations via a physical communications connection.

5. The communications system of claim 4, wherein each one of Ethernet router switches configures a plurality of Ethernet virtual connections between physical communications connections associated with the service providers.

6. The communications system of claim 5, each of the Ethernet virtual connections conforms to an Ethernet service profile associated with an end user of one of the plurality of service providers.

7. The communications system of claim 1, wherein the central server comprises:
a customer presentation module;
a management module for managing the plurality of Ethernet router switches;
a service module for monitoring Ethernet services, collecting and analyzing service data; and
a centralized service database for storing information associated with the plurality of service providers,
wherein,
the customer presentation module, the management module, the service module, the centralized service database are communicatively connected through a local interface of the central server.

8. The communications system of claim 7, wherein the central server is communicatively connected to a plurality of exchange points of presence of the Ethernet platform.

9. The communications system of claim 8, wherein each of the plurality of exchange points of presence comprises:
a management routing device;
a service monitoring traffic device;
a service testing traffic device;
a traffic examination and analysis device; and
a traffic switching and mapping device.

10. A method for facilitating interconnections between a plurality of communication service providers through an Ethernet switching platform, the method comprising:
establishing a connection between each of the plurality of service providers and the Ethernet switching platform, the plurality of service providers employing disparate Ethernet protocols;
determining each of the Ethernet protocols associated with each of the plurality of service providers;
establishing protocol mappings between any two Ethernet protocols for facilitating interconnections between corresponding service providers.

11. The method of claim 10, further comprising:
determining feasibility of service interconnects between the service providers, thereby minimizing a need to change service definitions and conducting interconnect testing.

12. The method of claim 10, further comprising:
shaping communication traffic between any two service providers by transforming communication data from one shape delivered to the platform by one service provider into another shape delivered by the platform to another service provider.

13. The method of claim 10, further comprising:
establishing dedicated Ethernet virtual connections (EVCs) between service providers, wherein EVCs conform to service profiles required by end users associated the service providers.

14. The method of claim 13, further comprising:
providing multiple classes of services between any two service providers over a corresponding dedicated EVC.

15. The method of claim 10, wherein the platform can support distant Ethernet local-area-network (E-LAN) services.

16. The method of claim 15, wherein E-LAN services can use multipoint-to-multipoint EVCs to enable a virtual LAN service over a wide are network (WAN).

17. The method of claim 10, further comprising:
monitoring traffic through one of the service providers by generating and communicating by the platform a synthetic data traffic to a user-to-network interface (UNI) of the one of the service providers and capturing the return version of the communicated synthetic data traffic.

18. The method of claim 17, further comprising:
comparing the communicated synthetic data traffic with the return version of the communicated synthetic data traffic to determine whether a deterioration in the synthetic data traffic occurred.

19. The method of claim 10, further comprising:
establishing a market place for Ethernet service providers and service purchasers.

20. The method of claim 19, wherein the market place is an on-line application, which resides on a server and is accessible by service providers and service purchasers through corresponding interfaces.

21. The method of claim 19, wherein the market place provides the service providers the ability to advertise geographic establishments where they provide Ethernet services and corresponding attributes.

22. The method of claim 21, wherein the Ethernet Services attributes comprise at least one of the following: service names, classes of service, service legal agreement guarantees, asset types, and install times.

23. The method of claim 19, wherein the market place provides Ethernet service purchasers the ability to search for geographical addresses served by any of the service providers connected to the platform.

24. The method of claim 19, wherein the market place enables service providers serving distinct geographical areas to exchange information to work together to establish end-to-end Carrier Ethernet services.

25. The method of claim 19, wherein the market place provide the service providers and service purchasers the ability to see inventories of provided and purchased services.

26. The method of claim 19, wherein the market place further provides information about the interworking of provided and purchased services, contact information between service providers, information about service monitoring thresholds on provided and purchased services.

27. The method of claim 19, wherein the market place provides service providers and purchases the ability to determine near-real time operational states of monitored service components of the platform and to extract historical monitoring service legal agreements for the platform components.

28. The method of claim 19, wherein the market place provides for the service providers and purchasers the ability to order, to change, and to delete connections which can flow through the platform.
